(19) United States
(12) Patent Application Publication
(10) Pub. No.: US 2015/0287219 A1
(43) Pub. Date: Oct. 8, 2015

(54) ELECTRONIC DEVICE AND METHOD FOR DYNAMICALLY INDICATING TRANSMISSION PROGRESS OF DATA

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HAI-SEN LIANG, Shenzhen (CN); CHIH-SAN CHIANG, New Taipei (TW); YA-LING LIU, Shenzhen (CN); HAI-JUN MAO, Shenzhen (CN); TE-JIA LIU, Shenzhen (CN); TAO LIU, Shenzhen (CN)

(21) Appl. No.: 14/642,435

(22) Filed: Mar. 9, 2015

(30) Foreign Application Priority Data
Apr. 2, 2014 (CN) 201410131622.8

(51) Int. Cl. G06T 11/00; G06T 11/60

(52) U.S. Cl. CPC G06T 11/001; G06T 11/60

(57) ABSTRACT

In a method for dynamically indicating data transmission progress using an electronic device, the method includes rendering in a first gray scale a background image corresponding to target data to be transmitted, acquiring a transmission completion percentage of the target data during a transmission process of the target data, and rendering in a second gray scale a portion of the background image having the transmission completion percentage.

### CROSS-REFERENCE TO RELATED APPLICATIONS

This application claims priority to Chinese Patent Application No. 201410131622.8 filed on Apr. 2, 2014, the contents of which are incorporated by reference herein.

### FIELD

The subject matter herein generally relates to communication technology field, and particularly to an electronic device and a method for dynamically indicating data transmission progress to users.

### BACKGROUND

Electronic devices usually display data transmission progress, such as uploading or downloading video files or electronic books in the form of a progress bar, a percentage, or a combination of a progress bar and a transmission completion percentage.

### BRIEF DESCRIPTION OF THE DRAWINGS

Implementations of the present disclosure will now be described, by way of example only, with reference to the attached figures.

FIG. 1 is a block diagram of an example embodiment of an electronic device.

FIG. 2 shows a diagrammatic view of an example of dynamically indicating data transmission progress.

FIG. 3 is a flowchart of an example embodiment of a method for dynamically indicating data transmission progress.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts can be exaggerated to better illustrate details and features of the present disclosure.

Several definitions that apply throughout this disclosure will now be presented.

The term “comprising” means “including, but not necessarily limited to”; it specifically indicates open-ended inclusion or membership in a so-described combination, group, series and the like. The term “module” refers to logic embodied in hardware or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

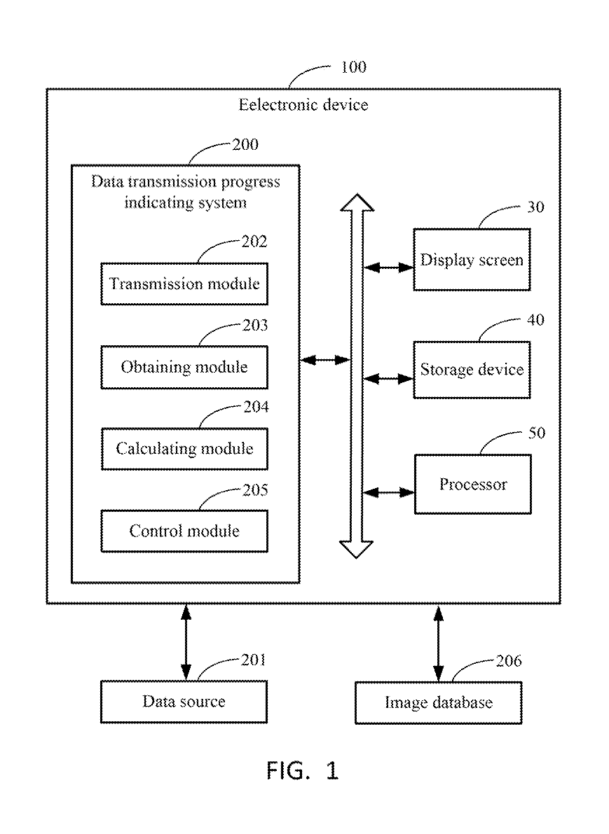

FIG. 1 is a block diagram of an example embodiment of an electronic device 100. The electronic device 100 can be mobile phones, tablet computers, personal digital assistants (PDAs), personal computers or any other electronic devices which can transmit data.

In at least one embodiment, the electronic device 100 includes, but is not limited to, a data transmission progress indicating system 200, a display screen 30, a storage device 40, and at least one processor 50. FIG. 1 illustrates only one example of the electronic device 100, and other examples can comprise more or fewer components then those shown in the embodiment, or have a different configuration of the various components.

In one embodiment, the data transmission progress indicating system 200 dynamically indicates data transmission progress to users according to a transmission completion percentage of target data.

The storage device 40 can be an internal storage device, such as a flash memory, a random access memory (RAM) for temporary storage of information, and/or a read-only memory (ROM) for permanent storage of information. The storage device 40 can also be an external storage device, such as an external hard disk, a storage card, or a data storage medium. In at least one embodiment, the processor 50 can be a central processing unit (CPU), a microprocessor, or other data processor chip that performs functions of the electronic device 100.

In one embodiment, the data transmission progress indicating system 200 includes a transmission module 202, an obtaining module 203, a calculating module 204, and a control module 205. Modules 202-205 can comprise computerized instructions in the form of one or more computer-readable programs that can be stored in a non-transitory computer-readable medium, for example in the storage device 40, and are executed by the at least one processor 50 of the electronic device 100 to provide functions of the present disclosure. A detailed description of the functions of the modules 202-205 is given below in reference to FIG. 1.

In one embodiment, the transmission module 202 can establish a connection with data source 201 of target data to be transmitted, and transmit the target data from an original address to a target address, such as uploading the target data from the electronic device 100 to a server, downloading the target data from a server to the electronic device 100, or moving the target data from one folder to another folder of the electronic device 100. The target data can be any type or any format, such as audio, video, text, image or other data which can be transmitted. The target data can be stored in the electronic device 100, other electronic devices, a storage device or a server.

The obtaining module 203 can obtain a background image corresponding to the target data. In a first embodiment, the background image is obtained from the target data if the target data itself includes the background image. In a second embodiment, the background image is randomly obtained from an image database 206 which includes a number of images. The image database 206 can be stored in the electronic device 100 or in a server. In a third embodiment, the obtaining module 203 can further obtain the property of the target data, and obtain from the image database 206 the image matching with the property of the target data. The property of the target data can be the classification or the file name of the target data.

The control module 205 can control the display screen 30 to display the background image and render the background image in a first gray scale.

The obtaining module 203 can further acquire a transmission completion percentage of the target data during a transmission process of the target data. The control module 205 can further render in a second gray scale a portion of the background image having the transmission completion percentage.

In the embodiment, the obtaining module 203 can further obtain a total area of the background image. The calculating module 204 can calculate an area of the portion of the background image according to the total area of the background image and the transmission completion percentage.

The control module 205 can render in the second gray scale a portion of the background image having the calculated area. That is, with the increase of the transmission completion percentage, the area of the portion of the background image rendered in the second gray scale will increase gradually, and the area of the remaining portion of the background image rendered in the first gray scale will reduce, in order to dynamically indicate/reflect the data transmission progress.

In the embodiment, the first gray scale and the second gray scale are two different colors having an obvious visual difference, for example, the first gray scale is black and white, and the second gray scale a color. Such that, the background image is shown as two portions having two obvious different colors, and makes gradual change to the size of the two portions, in order to dynamically show the data transmission progress.

In one embodiment, the portion of the background image rendered in the second gray scale can begin at one end portion of the background image, and expand from the one end portion to an opposite end portion of the background image as the data transmission progress advances. The one end portion of the background image can be any position of the background image, such as the left, the right, the upper, the lower, or one of the corners of the background image.

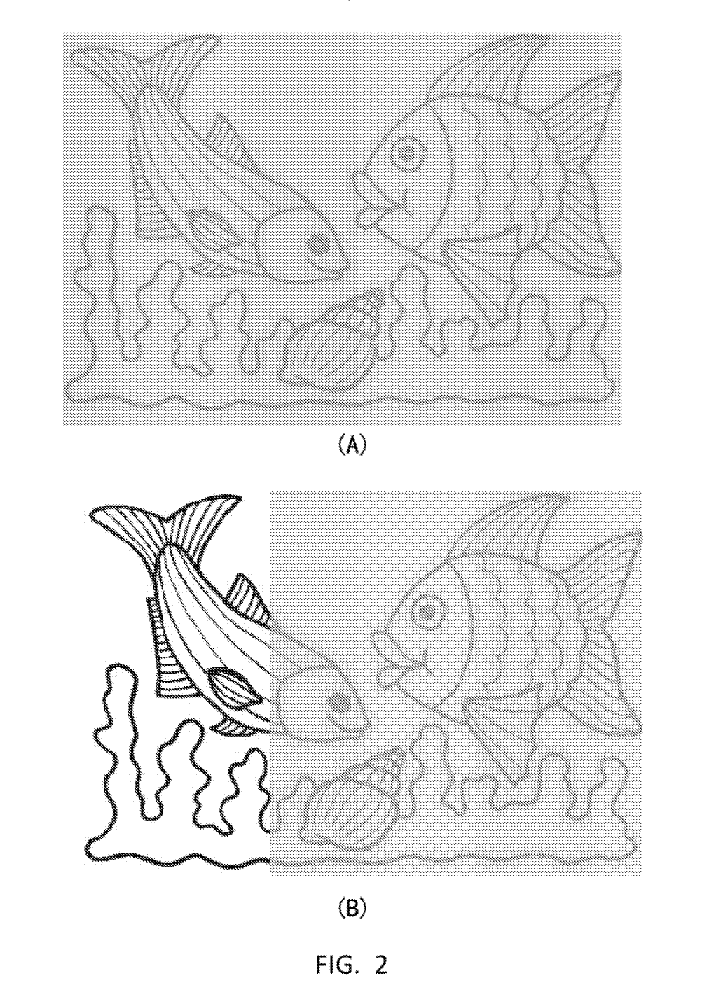

For example, as shown in FIG. 2(A), when the data transmission progress starts, the whole background image is rendered in gray. When the data transmission progress reaches the transmission completion percentage 30%, as shown in FIG. 2(B), 30% of the background image on the left is rendered in black and white. When the data transmission progress is finished, the whole background image is rendered in black and white.

In other embodiments, the portion of the background image rendered in a second gray scale can begin at a center of the background image, and expand from the center to the edges of the background image as the data transmission advances.

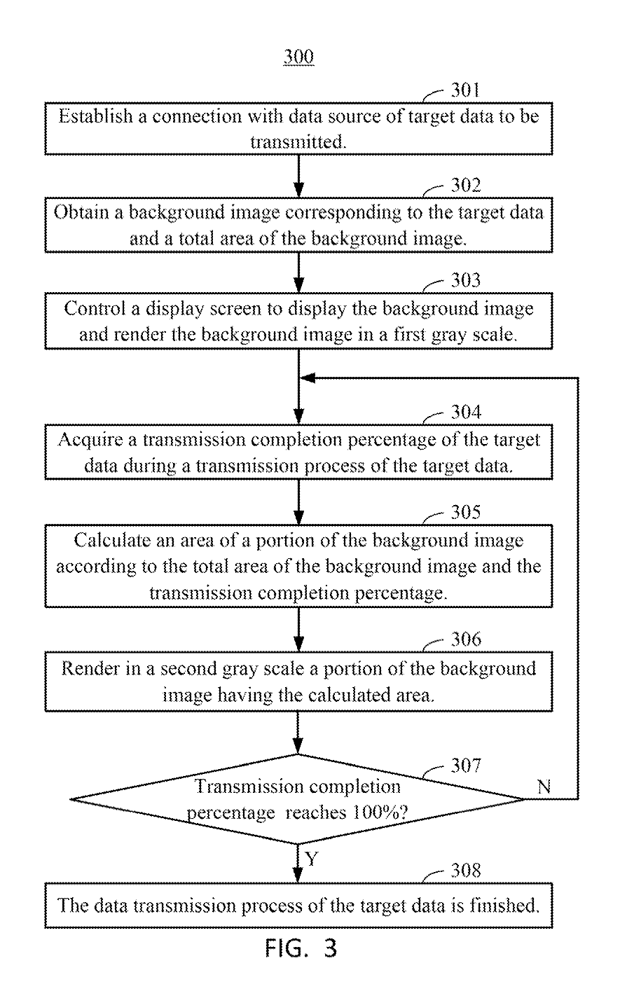

FIG. 3 illustrates a flowchart of an example embodiment of a method for dynamically indicating data transmission progress using an electronic device. In an example embodiment, the method 300 is performed by execution of computer-readable software program codes or instructions by at least one processor 50 of the electronic device 100.

Referring to FIG. 3, a flowchart is presented in accordance with an example embodiment which is being thus illustrated. The example method 300 is provided by way of example, as there are a variety of ways to carry out the method. The method 300 described below can be carried out using the configurations illustrated in FIG. 1, for example, and various elements of these figures are referenced in explaining method 300. Each block shown in FIG. 3 represents one or more processes, methods, or subroutines, carried out in the exemplary method 300. Furthermore, the illustrated order of blocks is by example only and the order of the blocks can change according to the present disclosure. Additional blocks can be added or fewer blocks can be utilized, without departing from this disclosure. The example method 300 can begin at block 301.

At block 301, a transmission module establishes a connection with data source of target data to be transmitted.

At block 302, an obtaining module obtains a background image corresponding to the target data and a total area of the background image.

At block 303, a control module controls a display screen of the electronic device to display the background image and renders the background image in a first gray scale.

At block 304, the obtaining module acquires a transmission completion percentage of the target data during a transmission process of the target data.

At block 305, a calculating module calculates an area of a portion of the background image according to the total area of the background image and the transmission completion percentage.

At block 306, the control module renders in a second gray scale a portion of the background image having the calculated area.

At block 307, the control module determines whether the transmission completion percentage reaches 100%. If the transmission completion percentage reaches 100%, block 308 is implemented. Otherwise, the process goes back to block 304.

At block 308, the control module determines that the data transmission process of the target data is finished, and then the process ends.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in particular the matters of shape, size, and arrangement of parts within the principles of the present disclosure, up to and including the full extent established by the broad general meaning of the terms used in the claims.

What is claimed is:

1. An electronic device comprising:
at least one processor;
at least one display screen coupled to the processor; and
a storage device that stores one or more programs, which when executed by the at least one processor, cause the at least one processor to:
obtain a background image corresponding to target data to be transmitted;
control the display screen to display the background image and render the background image in a first gray scale;
acquire a transmission completion percentage of the target data during a transmission process of the target data; and
render in a second gray scale a portion of the background image having the transmission completion percentage.

2. The electronic device as described in claim 1, wherein the at least one processor further obtains a total area of the background image, and the at least one processor renders in a second gray scale a portion of the background image having the transmission completion percentage by:
calculating an area of the portion of the background image according to the total area of the background image and the transmission completion percentage; and
rendering in the second gray scale a portion of the background image having the calculated area.

3. The electronic device as described in claim 1, wherein the portion of the background image rendered in the second gray scale begins at one end portion of the background image, and expands from the one end portion to an opposite end portion of the background image as the data transmission progress advances.

4. The electronic device as described in claim 3, wherein the one end portion of the background image is selected from a group consisting of the left, the right, the upper, the lower, and one of the corners of the background image.

5. The electronic device as described in claim 1, wherein the portion of the background image rendered in a second gray scale begins at a center of the background image, and expands from the center to the edges of the background image as the data transmission advances.

6. The electronic device as described in claim 1, wherein the background image is obtained from the target data if the target data itself comprises the background image.

7. The electronic device as described in claim 1, wherein the background image is obtained from an image database, wherein the image database comprises a plurality of images.

8. The electronic device as described in claim 7, wherein the at least one processor further obtains the property of the target data, and the obtained image matches with the property of the target data.

9. A computer-based method for dynamically indicating data transmission progress using an electronic device, the method comprising:
obtaining a background image corresponding to target data to be transmitted;
controlling a display screen of the electronic device to display the background image and render the background image in a first gray scale;
acquiring a transmission completion percentage of the target data during a transmission process of the target data; and
rendering in a second gray scale a portion of the background image having the transmission completion percentage.

10. The method as described in claim 9, further comprising:
obtaining a total area of the background image; and
rendering in a second gray scale a portion of the background image having the transmission completion percentage further comprising:
calculating an area of the portion of the background image according to the size of the background image and the transmission completion percentage; and
rendering in the second gray scale a portion of the background image having the calculated area.

11. The method as described in claim 9, wherein the portion of the background image rendered in the second gray scale begins at one end portion of the background image, and expands from the one end portion to an opposite end portion of the background image as the data transmission progress advances.

12. The method as described in claim 11, wherein the one end portion of the background image is selected from a group consisting of the left, the right, the upper, the lower, and one of the corners of the background image.

13. The method as described in claim 9, wherein the portion of the background image rendered in a second gray scale begins at a center of the background image, and expands from the center to the edges of the background image as the data transmission progress advances.

14. A non-transitory computer-readable medium having stored thereon instructions that, when executed by at least one processor of an electronic device, causing the electronic device to perform a method for dynamically indicating data transmission progress, the method comprising:
obtaining a background image corresponding to target data to be transmitted;
controlling a display screen of the electronic device to display the background image and render the background image in a first gray scale;
acquiring a transmission completion percentage of the target data during a transmission process of the target data; and
rendering in a second gray scale a portion of the background image having the transmission completion percentage.

15. The non-transitory computer-readable medium as described in claim 14, further comprising:
obtaining a total area of the background image; and
rendering in a second gray scale a portion of the background image having the transmission completion percentage further comprising:
calculating an area of the portion of the background image according to the size of the background image and the transmission completion percentage; and
rendering in the second gray scale a portion of the background image having the calculated area.
